(19) United States
(12) Patent Application Publication
(10) Pub. No.: US 2025/0241270 A1
(43) Pub. Date: Jul. 31, 2025

(54) Self-Cleaning Waste Disposal System

(71) Applicant: Marwan Raydan, Edmonton (CA)

(72) Inventor: Marwan Raydan, Edmonton (CA)

(21) Appl. No.: 18/425,225

(22) Filed: Jan. 29, 2024

(51) Int. Cl. A01K 1/01; B65G 45/12; B65G 45/22; B65G 45/24

(52) U.S. Cl. CPC A01K 1/0117

(57) ABSTRACT

A self-cleaning waste disposal system is provided. The self-cleaning waste disposal system includes a housing having a receptacle disposed beneath a conveyor belt, wherein the conveyor belt receives waste from an animal within the housing. The tray includes a drain that receives the waste and fluid from a sprayer system directed towards the conveyor belt. A sensor is operably connected to an upper end of the conveyor to detect the waste. Upon detection, the upper end of the conveyer belt automatically rotates towards a rear end of the housing the sprayer system disperses fluid on to the conveyer belt. A scraping member is disposed within the tray and can remove waste from the conveyer belt as the conveyor belt rotates. This prevents waste from returning to the top of the conveyer belt.

### BACKGROUND OF THE INVENTION

The present invention relates to waste removal systems. The present invention specifically provides a system having a conveyor belt and a cleaning system configured to automatically detect and clean waste from the conveyor belt.

Environment, such as cold or bad weather, age or mobility issues can prevent pet owners from taking their pets outside to go to the bathroom. Additionally, many pets do not want to go outside in bad weather. Many of these owners use pee pads or designated places in a residence for pets to use as a bathroom. Waste disposal systems for managing animal waste within confined spaces have been integral in various environments, ranging from residential homes, farms, and research facilities. Furthermore, pet waste disposal systems have been designed to address the challenges associated with maintaining a clean environment in spaces where animals reside. These systems traditionally involve manual cleaning leading to inefficiencies and hygiene challenges. These systems often involve manual intervention or lack an automated mechanism, leading to inefficiencies in waste management. Therefore, there is a need for an automated, self-cleaning waste disposal system that reduces manual labor when cleaning waste.

The shortcomings of current waste disposal systems are multifaceted. Manual cleaning methods are labor-intensive, time-consuming, and often fail to maintain optimal cleanliness levels. Existing stationary conveyor systems may not effectively prevent waste from returning to the top of the conveyor belt, compromising sanitation, and potentially causing health hazards. Moreover, existing systems lack a comprehensive mechanism to efficiently handle waste removal, fluid dispersion, and prevention of waste recontamination. Traditional pet waste disposal systems are evident in their reliance on manual cleaning procedures. Additionally, these systems may lack responsiveness to immediate waste detection, potentially leading to unpleasant odors and unhygienic conditions that persist over extended periods of time.

In light of the devices disclosed in the known art, it is submitted that the present invention substantially diverges in design elements and methods from the known art and consequently it is clear that there is a need in the art for an improvement of a self-cleaning waste disposal system. In this regard the instant invention substantially fulfills these needs.

### SUMMARY OF THE INVENTION

In view of the foregoing disadvantages inherent in the known types of self-cleaning waste disposal systems now present in the known art, the present invention provides a self-cleaning waste disposal system wherein the same can be utilized for automatically detecting and cleaning waste from a conveyor belt.

It is an objective of the present invention to provide a self-cleaning waste disposal system having a housing with a receptacle disposed within a base, wherein the base comprises a front end and a rear end. A conveyor belt is disposed within the base of the housing, wherein the conveyor belt comprises an upper end and a lower end. A drain is disposed within the tray and receives waste and fluid from a sprayer system configured to spray waste from the conveyor belt. A sensor is operably connected to the conveyor belt and configured to detect waste on the conveyor belt. Upon detection, the upper end of the conveyer belt automatically rotates towards the rear end of the base and the primary sprayer disperses fluid onto the conveyer belt.

It is another objective of the present invention to provide a self-cleaning waste disposal system having a scraping member disposed within the tray adapted to remove waste from the conveyer belt as the conveyor belt rotates. The scraping mechanism prevents waste from returning to the top of the conveyer belt.

It is another objective of the present invention to provide a self-cleaning waste disposal system having a waste tube comprising a first end connected to the drain and a second end extending within the base. A second drain is disposed on the base configured to allow fluid from the waste tube to pass therethrough and exit the housing.

It is therefore an object of the present invention to provide a new and improved self-cleaning waste disposal system that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a front perspective view of an embodiment of the self-cleaning waste disposal system.

FIG. 2 shows a top-down view of an embodiment of the self-cleaning waste disposal system.

FIG. 3 shows a side transparent view of an embodiment of the self-cleaning waste disposal system.

FIG. 4 shows a transparent view of the conveyor belt and receptacle within the base of an embodiment of the self-cleaning waste disposal system.

FIG. 5 shows a bottom perspective view of an embodiment of the self-cleaning waste disposal system.

FIG. 6 shows a perspective view of the waste tube of an embodiment of the self-cleaning waste disposal system.

FIG. 7 shows a block diagram of an embodiment of the self-cleaning waste disposal system.

### DETAILED DESCRIPTION OF THE INVENTION

Reference is made herein to the attached drawings. For the purpose of presenting a brief and clear description of the present invention, the preferred embodiment will be discussed as used for automatically detecting and cleaning waste from the conveyor belt. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment.

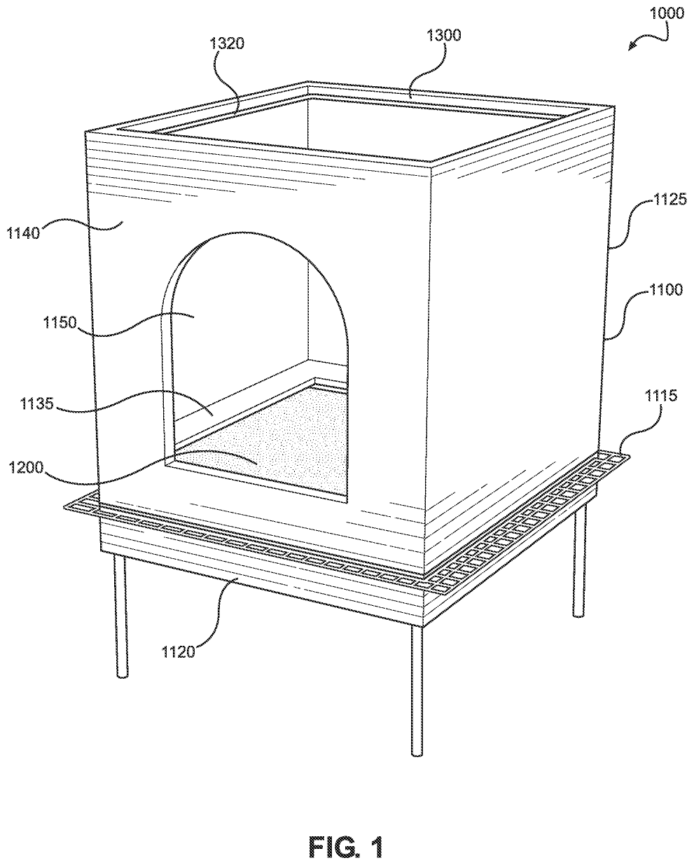

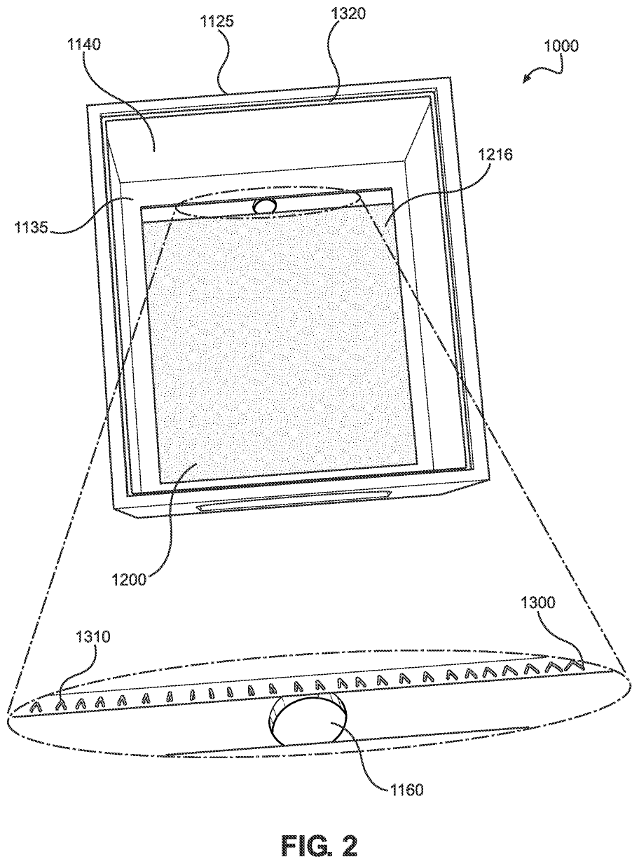

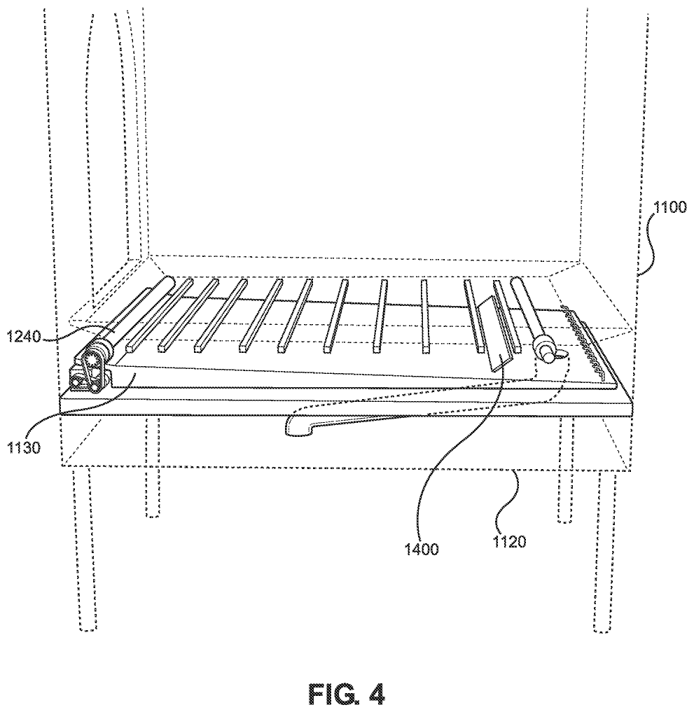

Referring now to FIGS. 1 and 2, there is shown a front perspective view of an embodiment of the self-cleaning waste disposal system and a top-down view of an embodiment of the self-cleaning waste disposal system, respectively. The self-cleaning waste disposal system 1000 comprises a housing 1100 having a base 1120 configured to house a tray (as seen in FIG. 4, 1130). A conveyor belt 1200 is disposed within the base 1120, above the tray. The conveyor belt 1200 is configured to receive waste from an animal, such as a pet or any other type of animal, wherein upon receipt of the waste, the conveyor belt automatically rotates toward a rear end 1125 of the housing to allow the waste to fall off of the conveyor belt 1200. A sprayer system 1300 is operably connected to the housing 1100 and adapted to spray water or cleaning solution to clean the conveyor belt as it is rotated.

In the illustrated embodiment, the base 1120 comprises a rectangular cross-section. However, in alternate embodiments, the base comprises any suitable shape, such as a square, round, or irregular shaped cross-section. In some embodiments, the housing 1100 further comprises a plurality of sidewalls 1140 extending from the base 1120. At least one sidewall 1140 comprises an opening or entrance 1150 for the animal to enter the housing 1100. In the illustrated embodiment, the entrance is arched. In the illustrated embodiment, the base 1120 is aligned with the sidewalls 1140 and separable therefrom via a friction fit or other fastener, such as an interlocking mechanism. In the illustrated embodiment, a wire frame 1115 is disposed within the base 1120, beneath the tray 1130, to catch any additional waste that may not have been disposed of through a drain 1160.

In the illustrated embodiment, the sprayer system 1300 comprises a primary sprayer 1310 and a secondary sprayer 1320. The primary sprayer 1310 is disposed within the base 1120 along the rear end of the housing 1100, directed toward a rear end 1210 of the conveyor belt 1200. The primary sprayer 1310 comprises a plurality of individual sprayers 1315 operably connected to a fluid reservoir 1350 containing water or other a cleaning solution. In the illustrated embodiment, the base 1120 comprises a ledge 1135 around an upper perimeter edge to prevent the spray from the primary sprayer from passing the upper boundary of the base. In this way, the spray is prevented from inadvertently spraying an animal on the conveyor belt 1200. In the illustrated embodiment, the ledge 1135 also extends around a majority of a perimeter of the conveyor belt 1200 to prevent an animal from entering the tray or slipping off the sides of the conveyor belt 1200.

The secondary sprayer 1320 extends from an upper end of a sidewall 1340 of the housing 1100 and is configured to release fluid on an interior of the sidewall. The fluid can be from the same source as the primary sprayer or operably connected to a different fluid source. The fluid is intended to cascade down all of the sidewalls to clean the sidewalls from any animal waste, such as urine. A drain 1160 is disposed within the tray to allow the fluid and waste to be disposed of.

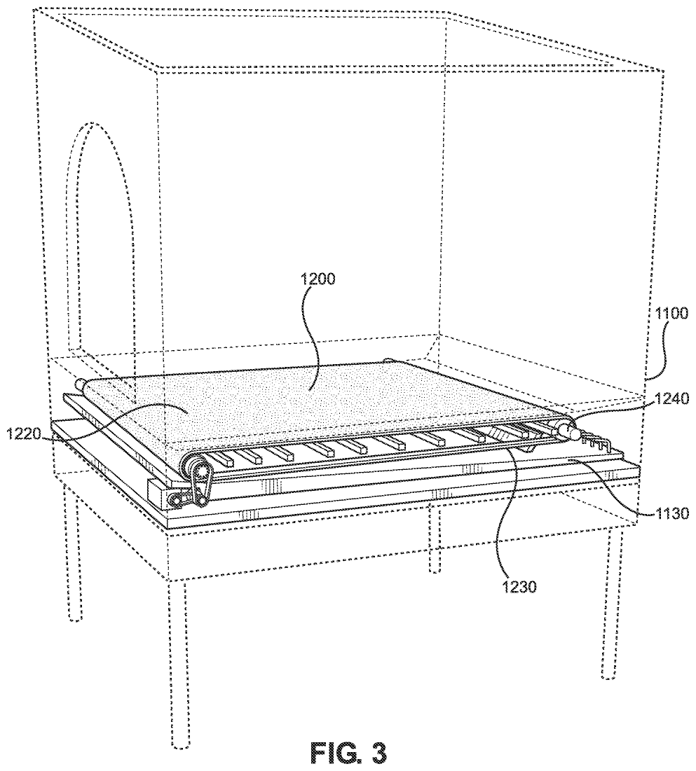

Referring now to FIGS. 3 and 4, there is shown a side transparent view of an embodiment of the self-cleaning waste disposal system and a transparent view of the conveyor belt and receptacle within the base of an embodiment of the self-cleaning waste disposal system, respectively. In the illustrated embodiment, the conveyor belt 1200 comprises an upper end 1220 and a lower end 1230, wherein the belt is made of a washable, non-absorbable material such as rubber. A plurality of spaced rollers 1240 are disposed at the rear and front ends of the belt, as well as therebetween, to rotate and support the conveyor belt in a planar formation.

In the illustrated embodiment, the tray 1130 is disposed against the sides of the base 1120 and/or comprise raised lateral edges to prevent waste or fluid from falling over the sides thereof. In the illustrated embodiment, the tray 1130 is sloped downwards towards the rear end of the housing 1100 and towards the drain. In alternate embodiments, it is contemplated that the tray is sloped towards a center or the front end of the housing. The purpose of the sloped tray is to funnel the waste and fluid towards a drain.

In the illustrated embodiment, the self-cleaning waste disposal system 1000 comprises a scraping member 1400 positioned within the tray 1130 and angled towards the rear end of the housing 1100. The scraping member 1400 is an elongated knife extending between lateral sides of the conveyor belt. The scraping member 1400 is adapted to remove or mechanically scrape waste from the conveyer belt as the conveyor belt rotates and prevent waste from returning to the top of the conveyer belt. The scraping member 1400 can be any suitable member, such as an air knife, liquid jets, or other mechanical scraper.

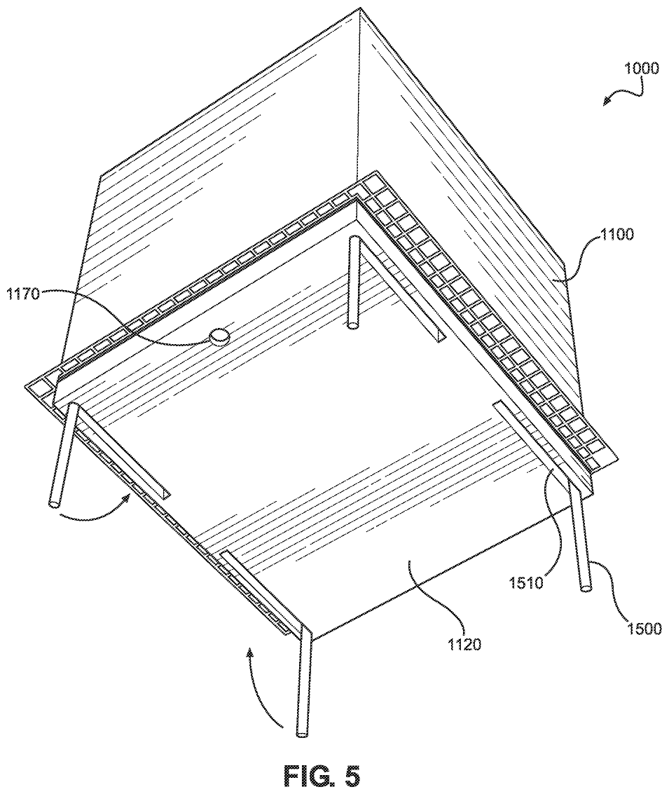

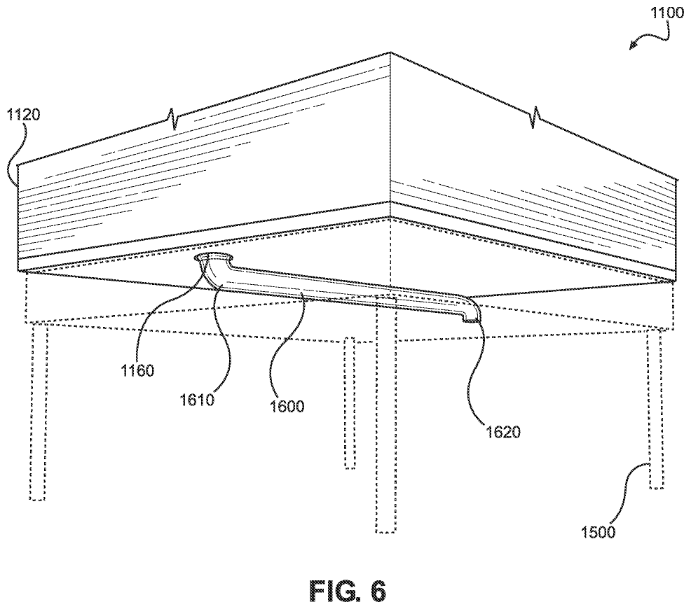

Referring now to FIGS. 5 and 6, there is shown a bottom perspective view of an embodiment of the self-cleaning waste disposal system and a perspective view of the waste tube of an embodiment of the self-cleaning waste disposal system, respectively. In the illustrated embodiment, the housing 1100 further comprises a support leg 1500 extending from the base 1120 and configured to raise the housing from a surface. The base 1120 comprises a slot 1510 configured to receive the support leg 1500 in a folded and stored position. In alternate embodiments, the base 1120 is configured to rest flush on a surface.

In the illustrated embodiment, self-cleaning waste disposal system 1000 comprises a waste tube 1600 having a first end 1610 connected to the drain 1160 and a second end 1620 extending within the base 1120. A second drain 1170 is disposed on the base 1120 and configured to allow fluid from the waste tube 1600 to pass therethrough. In the illustrated embodiment, the second drain 1170 is disposed on a bottom of the base at a rear end of the housing 1100.

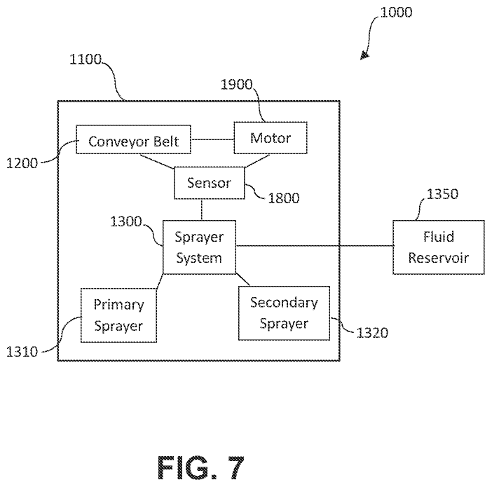

Referring now to FIG. 7, there is shown a block diagram of an embodiment of the self-cleaning waste disposal system. In the illustrated embodiment, the self-cleaning waste disposal system is automated via a sensor 1800 configured to detect waste on the conveyor belt operably connected to a motor 1900 and the sprayer system 1300. The motor is operably connected to the conveyor belt and adapted to rotate the conveyor belt when signaled. In the illustrated embodiment, the sensor is a weight sensor, but in alternate embodiments, the sensor comprises any suitable sensor capable of detecting waste on the conveyor belt. Upon detection by the sensor 1800, the upper end of the conveyer belt 1200 automatically rotates towards the rear end of the base and the primary sprayer disperses fluid on to the conveyer belt. The secondary sprayer simultaneously or consecutively cascades fluid down the interior sidewalls of the housing. Any remaining waste is removed by the scraping member as the conveyor belt rotates. In one embodiment, the conveyor belt is actuated by manual control, such as a rotatable arm linked to the conveyor belt. In this way, the conveyor belt is selectively controlled without motors. In some embodiments, both motors and manual control are disposed on the device for selective actuation.

In some embodiments, the sensor 1800 is operably connected to an application downloadable on a user's electronic device, such that when waste is detected, the user is notified. In some embodiments, the self-cleaning waste disposal system comprises a camera that allows the user to observe the interior of the housing at any time. In other embodiments, the self-cleaning waste disposal system comprises a motion sensor that also allows a user to be notified when an animal has entered the housing.

The embodiment described herein is used as a pet waste receiving and removal system, for example with dogs, cats, and birds kept in a birdcage. The system can be used inside or outside of a home or other building structure. The system is also configured to be used in industry, such as with farm animals. In some embodiments, it is contemplated that the self-cleaning waste disposal system can be used for other types of waste removal, such as snow removal from a driveway, roof of a building, roof of a car, or trash removal, and the like.

The present invention allows pets and other animals to go to the bathroom indoors in a designated area, wherein the system automatically cleans and disposes of the waste on a rolling conveyor. In some embodiments, the entire system is enclosed, similar to a kennel, to control smells and odors.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-cleaning waste disposal system, comprising:
a housing having a receptacle disposed within a base, wherein the base comprises a front end and a rear end;
the housing comprising a conveyor belt having an upper end and a lower end;
a drain disposed within a tray;
a sprayer system having a primary sprayer extending from the rear end of the base, wherein the primary sprayer is directed towards the conveyor belt;
a sensor configured to detect waste on the conveyor belt;
wherein upon detection of the waste, the upper end of the conveyer belt is configured to automatically rotate towards the rear end of the base and the primary sprayer is configured to disperse fluid on to the conveyer belt;
a scraping member disposed within the tray adapted to remove the waste from the conveyer belt as the conveyor belt rotates and to prevent waste from returning to the top of the conveyer belt.

2. The self-cleaning waste disposal system of claim 1, further comprising a motor operably connected to the conveyor belt.

3. The self-cleaning waste disposal system of claim 1, further comprising a support leg extending from the housing and configured to raise the housing from a surface.

4. The self-cleaning waste disposal system of claim 3, wherein the base comprises a slot configured to receive the support leg in a stored position.

5. The self-cleaning waste disposal system of claim 1, wherein the housing comprises a plurality of sidewalls, wherein an entrance opening is disposed within one of the plurality of sidewalls.

6. The self-cleaning waste disposal system of claim 5, wherein the plurality of sidewalls are separable from the base of the housing.

7. The self-cleaning waste disposal system of claim 1, wherein the sprayer system further comprises a secondary sprayer extending from a sidewall of the housing, the secondary sprayer is configured to release fluid on an interior of the sidewall.

8. The self-cleaning waste disposal system of claim 1, further comprising a plurality of spaced rollers configured to support the conveyor belt in a planar formation.

9. The self-cleaning waste disposal system of claim 1, a waste tube having a first end connected to the drain and a second end extending within the base.

10. The self-cleaning waste disposal system of claim 9, further comprising a second drain disposed on the base configured to allow fluid from the waste tube to pass therethrough.

11. The self-cleaning waste disposal system of claim 10, wherein the second drain is disposed on a bottom of the base at a rear end of the housing.

12. The self-cleaning waste disposal system of claim 1, wherein the tray is sloped downwards towards the rear end.

13. The self-cleaning waste disposal system of claim 1, wherein the scraping member is positioned within and angled towards the rear end.

14. The self-cleaning waste disposal system of claim 1, wherein the scraping member is an elongated knife extending between lateral sides of the conveyor belt.
